(19) United States
(12) Patent Application Publication
(10) Pub. No.: US 2014/0231107 A1
(43) Pub. Date: Aug. 21, 2014

(54) AUTOMATIC FIRE-EXTINGUISHING AND FIRE-FIGHTING DEVICE FOR ELECTRIC AUTOMOBILE

(71) Applicant: XI'AN XINZHU FIRE & RESCUE EQUIPMENT LIMITED COMPANY, Xi'an Shaanxi (CN)

(72) Inventors: Huru Wang, Xi'an Shaanxi (CN); Lei Wang, Xi'an Shaanxi (CN); Jie Yan, Xi'an Shaanxi (CN)

(73) Assignee: XI'AN XINZHU FIRE & RESCUE EQUIPMENT LIMITED COMPANY, Xi'an Shaanxi (CN)

(21) Appl. No.: 14/234,543

(22) PCT Filed: Nov. 13, 2012
(86) PCT No.: PCT/CN2012/084545

§ 371 Date: Jan. 23, 2014

(30) Foreign Application Priority Data
Nov. 17, 2011 (CN) 201120455688.4

(51) Int. Cl. A62C 3/07

(52) U.S. Cl. CPC A62C 3/07
USPC 169/58; 169/56

(57) ABSTRACT

An automatic fire-extinguishing and fire-fighting device for an electric automobile, comprising a powder bottle (2), a bottle head valve (4) connected to the lower part of the powder bottle (2), and a gas bottle (5) connected to the lower part of the bottle head valve (4); the powder bottle (2) is connected to the bottle head valve (4) via a truncated-cone-shaped connecting piece (7); a central gas outlet (9) is disposed along an axis; three lateral gas outlets (10) are uniformly distributed on a side surface; an angle of 100 degrees is formed between the lateral gas outlets (10) and the central axis of the powder bottle (2). The automatic fire-extinguishing and fire-fighting device for an electric automobile separates the powder bottle from the gas bottle, improving device safety and stability; the connection structure enables the gas and powder to be fully mixed, thus achieving better fire-extinguishing and fire-fighting effect.

### TECHNICAL FIELD

The present disclosure pertains to the mechanical field and relates to an automatic fire-extinguishing and fire-fighting device, more particularly, to an automatic fire-extinguishing and fire-fighting device for an electric automobile.

### BACKGROUND ART

Once the electric automobiles collides fiercely, the battery packet easily deforms or the electrolyte easily leaks, causing fire, the electric automobile needs to carry a fire-extinguishing device; the existing fire-extinguishing device for an electric automobile has a large volume, a powder bottle and a gas bottle integrate, and no protective cover is disposed at the outer walls of the powder bottle and the gas bottle, because the protective cover occupies a large space of the electric automobile, and since the powder bottle and the gas bottle integrate, the fire-extinguishing device may be erroneously opened, which lacks enough safety and stability; a traditional bottle head valve is made of a gunpowder device (referred to as a powder charge) wrapped by a rubber housing, since the present device is suitable for electric automobiles, the diameter of the pipe network thereof is small, if a traditional powder charge is used in the device, when the powder charge is detonated, the outer rubber housing for wrapping the powder charge may sputter into the pipe, causing a poor sputtering effect, and the pipe may be blocked; also, since the powder bottle and the gas bottle integrate, there is not sufficient space for high-pressure nitrogen gas in the gas bottle and dry powder in the powder bottle being mixed, resulting in insufficient mixture of high-pressure nitrogen gas and dry powder and affecting the fire-extinguishing effect.

### SUMMARY

The present disclosure aims to overcome the disadvantage in the above prior art, and provides an automatic fire-extinguishing and fire-fighting device for an electric automobile which adopts a structure of separating the powder bottle and the gas bottle a bottle head valve is disposed between the powder bottle and the gas bottle, thereby reducing the volume of the automatic fire-extinguishing and fire-fighting device and improving safety, stability and portability of the automatic fire-extinguishing and fire-fighting device.

The present disclosure is carried out through the following solutions:

The automatic fire-extinguishing and fire-fighting device for an electric automobile comprises a powder bottle, a bottle head valve connected to the lower part of the powder bottle and a gas bottle connected to the lower part of the bottle head valve, the powder bottle is connected to the bottle head valve via a connecting piece.

The middle portion of the powder bottle is a cylinder, the top end portion and the bottom end portion thereof are cones, the top end portion of the powder bottle is connected with a connector, and the bottom end portion of the powder bottle is disposed with a connecting piece.

The connecting piece is in a truncated-cone-shape, a central gas outlet is disposed along an axis, three lateral gas outlets are uniformly distributed on a side surface, and an angle of 100 degrees is formed between the lateral gas outlets and the central axis of the powder bottle.

The bottle head valve includes a lower valve body, the upper part of the lower valve body is disposed with a transition valve body, and an upper valve body is disposed on the upper part of the transition valve body; a puncture needle is disposed within the transition valve body, and a piston is nested-mounted on the upper part of the puncture needle; a puncture film is disposed within the lower valve body, and an internal nut is disposed on the puncture film.

Two gaskets having the same size are disposed on upper and lower parts of the puncture film, respectively.

The transition valve body is disposed with a first ladder hole and a second ladder hole having the same axis with the first ladder hole, a puncture needle runs through the second ladder hole, and a piston is nested-mounted on the upper part of the puncture needle; a small hole at the middle of the second ladder hole slides to cooperate with the puncture needle, an upper hole thereof slides to cooperate with the piston, and a lower hole thereof is nested-mounted on the lower valve body; a puncture film is disposed at the bottom of the upper hole of the first ladder hole, an internal nut is disposed on the puncture film, an anti-vibration gasket is disposed on the upper part of the internal nut, the diameter of the lower part of the puncture needle is less than the diameter of the upper part of the puncture needle, and the transition surface thereof leans against the inner race of the anti-vibration gasket; the upper valve body is disposed with a third ladder hole having the same axis with the first ladder hole, the upper hole of the third ladder hole slides to cooperate with the puncture needle, and the lower hole thereof, the transition valve body, the upper part of the piston and the outer wall of the puncture needle form an annular sealed cavity, and a trigger is disposed within the annular sealed cavity.

A line pressing plate is disposed at a joint between the horizontal plane of the upper end portion of the transition valve body and the upper valve body, a lead hole is disposed on the line pressing plate, the trigger is connected to a connecting box disposed on a shield through a lead passing through the lead hole.

The trigger is a powder blasting box or a powder cartridge made by suppressing powder.

The diameter of the lower part of the puncture needle is less than the diameter of the upper part thereof, the transition surface thereof leans against the inner race of the anti-vibration gasket, the level angle of the tip of the puncture needle is ranging from 10 to 20 degrees.

The side wall of the transition valve body is opened with a gas exhausting hole, the lower part of the piston, the outer wall of the puncture needle and the transition valve body form an annular cavity, and the gas exhausting hole is connected with the annular cavity.

A gasket is disposed on the top end portion of the bottle head valve and the bottom of the connecting piece, and a cooper gasket for seal is disposed at a joint between the bottom of the bottle head valve and the gas bottle.

The powder bottle is welded with the connecting piece, the connecting piece is connected to the bottle head valve thread, and the bottle head valve is connected to the gas bottle thread.

The bottom of the powder bottle, the bottle head valve and the gas bottle are fixedly disposed within a shield, the gas bottle and the bottom of the shield flushes, the powder bottle is connected to the shield thread, and the shield and the gas bottle are solidified with an anaerobic adhesive.

The powder bottle and the outer wall of the shield are both socketed with supports, and a rubber pad is disposed within the support.

A filing valve, a pressure sensor and a safety relief device are uniformly disposed along the circumference on the top of the gas bottle.

The advantageous effects of the present disclosure are: the automatic fire-extinguishing and fire-fighting device for an electric automobile has a small volume, in which a powder bottle and a gas bottle are separated, a protective cover is disposed at the outer walls of the powder bottle and the gas bottle, a bottle head valve is disposed between the powder bottle and the gas bottle, thereby improving safety and stability of the automatic fire-extinguishing and fire-fighting device for an electric automobile; a trigger made by suppressing the powder charge is adopted in the the automatic fire-extinguishing and fire-fighting device for an electric automobile of the present disclosure, the phenomenon of blocking the pipe never occurs when the powder charge is detonated; meanwhile, a bottle head valve is adopted so that there is sufficient space for high-pressure nitrogen gas in the gas bottle and dry powder in the powder bottle being mixed, so that high-pressure nitrogen gas and dry powder can be fully mixed, thereby improving the fire-extinguishing effect.

### BRIEF DESCRIPTION OF THE DRAWINGS

FIG. 1 is a structure diagram of the dry powder fire-extinguishing device of the present disclosure;

FIG. 2 is a structure diagram of the connector of the present disclosure;

FIG. 3 is a structure diagram of the powder bottle of the present disclosure;

FIG. 4 is a cross-section diagram of the connecting piece of the present disclosure;

FIG. 5 is a structure diagram of the connecting piece of the present disclosure;

FIG. 6 is a structure diagram of the bottle head valve of the present disclosure;

FIG. 7 is a structure diagram of the gas bottle of the present disclosure; wherein 1 is connector; 2 is powder bottle; 3 is support; 4 is bottle head valve; 5 is gas bottle; 6 is shield; 7 is connecting piece; 8 is trigger; 9 is central gas outlet; 10 is lateral gas outlet; 11 is upper valve body; 12 is transition valve body; 13 is lower valve body; 14 is puncture needle; 15 is piston; 16 is puncture film; 17 is internal nut; 18 is line pressing plate; 19 is lead hole; 20 is cooper pad; 21 is gas exhausting hole; 22 is pressure sensor; 23 is a filing valve.

### DETAILED DESCRIPTION OF EXEMPLARY EMBODIMENTS

Below the embodiments are described in detail with reference to the accompanying drawings to explain the present disclosure.

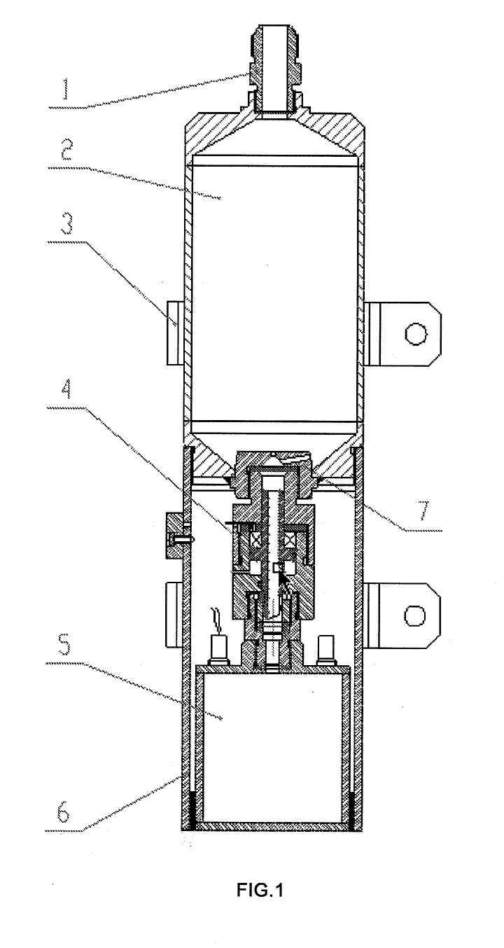

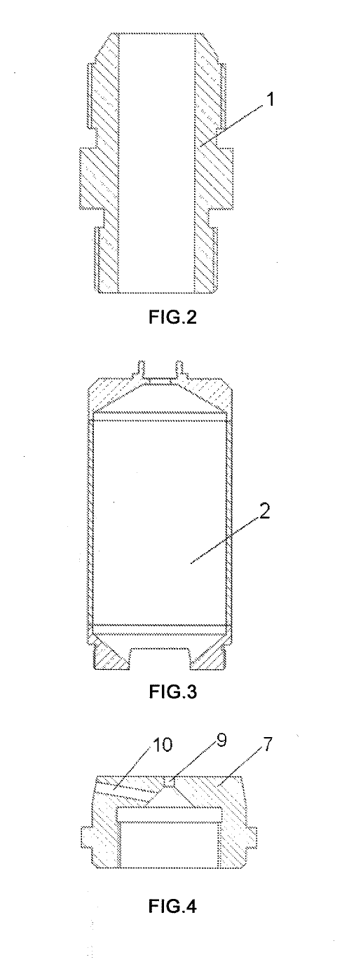

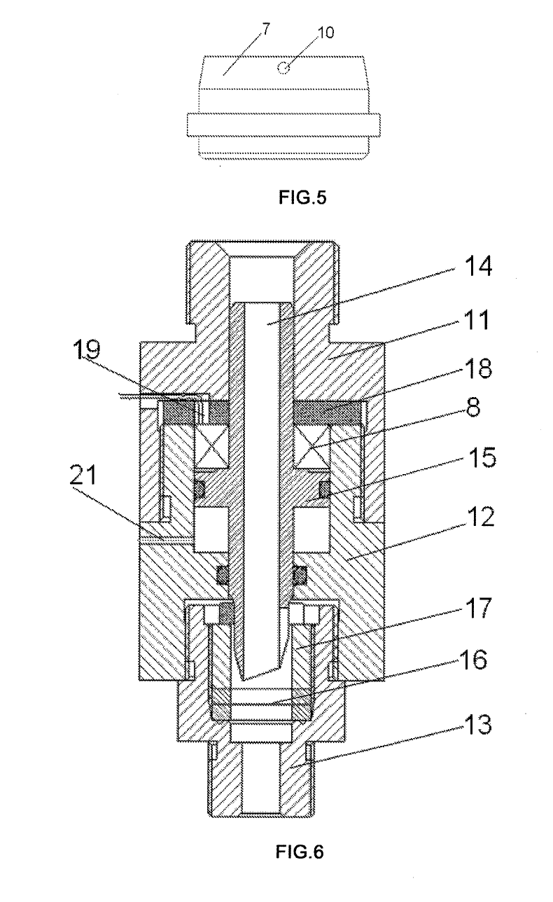

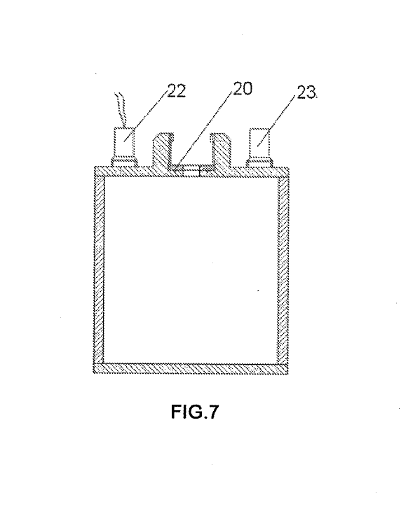

Referring to FIGS. 1-7, an automatic fire-extinguishing and fire-fighting device for an electric automobile comprises a powder bottle (2), a bottle head valve (4) connected to the lower part of the powder bottle (2) and a gas bottle (5) connected to the lower part of the bottle head valve (4), the top end portion of the powder bottle (2) may be connected to a connector (1). The fire-extinguishing and fire-fighting device is mounted in a manner: the gas bottle (5) and the powder bottle (2) are separated with the bottle head valve (4) disposed therebetween, the gas bottle (5) and the powder bottle (2) are connected and strengthened by a shield (6). Such separate-type structure greatly reduces the whole size of the device and enables the volume of the device to be smaller and to be readily mounted within the electric automobile, and such structure may enable the device to be mounted in a manner of any positions, as a result, when automobile are fiercely tumbling, the device can still work normally.

The middle portion of the powder bottle (2) is a cylinder, the top end portion and the bottom end portion thereof are cones, the top end portion of the powder bottle (2) is connected with a connector (1), and the bottom end portion of the powder bottle (2) is disposed with a connecting piece (7).

The connecting piece (7) is in a truncated-cone-shape, a central gas outlet (9) is disposed along an axis, three lateral gas outlets (10) are uniformly distributed on a side surface, and an angle of 100 degrees is formed between the lateral gas outlets (10) and the central axis of the powder bottle (2).

The bottle head valve (4) includes a lower valve body (13), the upper part of the lower valve body (13) is disposed with a transition valve body (12), and an upper valve body (11) is disposed on the upper part of the transition valve body (12); a puncture needle (14) is disposed within the transition valve body (12), and a piston is nested-mounted on the upper part of the puncture needle (14); a puncture film (16) is disposed within the lower valve body (13), and an internal nut (17) is disposed on the puncture film (16).

Two gaskets having the same size are disposed on upper and lower parts of the puncture film (16), respectively.

The transition valve body (12) is disposed with a first ladder hole and a second ladder hole having the same axis with the first ladder hole, a puncture needle (14) runs through the second ladder hole, and a piston (15) is nested-mounted on the upper part of the puncture needle (14); a small hole at the middle of the second ladder hole slides to cooperate with the puncture needle (14), an upper hole thereof slides to cooperate with the piston (15), and a lower hole thereof is nested-mounted on the lower valve body (13); a puncture film (16) is disposed at the bottom of the upper hole of the first ladder hole, an internal nut (17) is disposed on the puncture film, an anti-vibration gasket is disposed on the upper part of the internal nut (17), the diameter of the lower part of the puncture needle (14) is less than the diameter of the upper part of the puncture needle (14), and the transition surface thereof leans against the inner race of the anti-vibration gasket; the upper valve body (11) is disposed with a third ladder hole having the same axis with the first ladder hole, the upper hole of the third ladder hole slides to cooperate with the puncture needle (14), and the lower hole thereof, the transition valve body (12), the upper part of the piston (15) and the outer wall of the puncture needle (14) form an annular sealed cavity, and a trigger (8) is disposed within the annular sealed cavity.

A line pressing plate (18) is disposed at a joint between the horizontal plane of the upper end portion of the transition valve body (12) and the upper valve body (11), a lead hole (19) is disposed on the line pressing plate (18), the trigger (8) is connected to a connecting box disposed on a shield (6) through a lead passing through the lead hole (19).

The trigger (8) is a powder blasting box or a powder cartridge made by suppressing powder.

The diameter of the lower part of the puncture needle (14) is less than the diameter of the upper part thereof, the transition surface thereof leans against the inner race of the anti-vibration gasket, the level angle of the tip of the puncture needle (14) is ranging from 10 to 20 degrees.

The side wall of the transition valve body (12) is opened with a gas exhausting hole (21), the lower part of the piston (15), the outer wall of the puncture needle (14) and the transition valve body (12) form an annular cavity, and the gas exhausting hole (21) is connected with the annular cavity.

A gasket is disposed on the top end portion of the bottle head valve (4) and the bottom of the connecting piece (7), and a cooper gasket for seal is disposed at a joint between the bottom of the bottle head valve (4) and the gas bottle (5).

The powder bottle (2) is welded with the connecting piece (7), the connecting piece (7) is threaded connected to the bottle head valve (4), and the bottle head valve (4) is threaded connected to the gas bottle (5).

The bottom of the powder bottle (2), the bottle head valve (4) and the gas bottle are fixedly disposed within a shield (6), the gas bottle (5) and the bottom of the shield (6) flushes, the powder bottle (2) is threaded connected to the shield (6), and the shield (6) and the gas bottle (5) are solidified with an anaerobic adhesive.

The powder bottle (2) and the outer wall of the shield (6) are both socketed with supports, and a rubber pad is disposed within the support (3).

A filing valve (23), a pressure sensor (22) and a safety relief device are uniformly disposed along the circumference on the top of the gas bottle (5).

The gas exhausting hole (21) functions to expel the air within the annular cavity when the piston (15) is moving, so that the puncture needle (14) can normally move.

The gas bottle (5) and the bottom of the shield (6) flushes, and the solidified anaerobic adhesive is filled in the gap between the gas bottle (5) and the shield (6). The whole device is monolithic and seems to be beautiful and generous, an ignition lead to be used and a connecting line of the pressure sensor (22) are both wrapped in the shield (6), such that the connecting line and the lead will not be exposed outside of the device and can be protected to avoid disorganization.

A connecting piece (7) is disposed at the bottom of the powder bottle (2), three uniformly distributed lateral gas holes are opened at the bottom of the powder bottle (2) connecting piece (7), and the lateral gas holes and the middle axis of the powder bottle (2) form an angle of 100 degrees. When the bottle head valve (4) is opened, high-pressure nitrogen gas in the gas bottle (5) enters into the powder bottle (2) through the three lateral gas holes at the bottom of the powder bottle (2), to be fully mixed with dry powder in a spiral state and arrives at a fire source through a pipe. Such sputtering manner results in full mixture of the gas and powder, thereby achieving better fire-extinguishing and fire-fighting effects.

The trigger (8) is disposed on the bottle head valve (4) and is a powder cartridge made by suppressing powder. The traditional bottle head valve (4) is made of a gunpowder device (referred to as a powder charge) wrapped by a rubber housing, since the present device is suitable for electric automobiles, the diameter of the pipe network thereof is small, if a traditional powder charge is used in the device, when the powder charge is detonated, the outer rubber housing for wrapping the powder charge may sputter into the pipe, causing a poor sputtering effect. Hence, the present device uses a trigger (8) totally made by suppressing powder, such that the phenomenon of blocking the pipe never occurs when the powder charge is detonated, which greatly improves usability and safety of the this device.

The fire-extinguishing device is disposed with a connector (1), the lower part of the connector (1) is connected with the powder bottle (2) by welding, the lower part of the powder bottle (2) is threaded connected to the bottle head valve (4), such inversion structure may rapidly react to speed up sputtering when the fire-extinguishing device is used. The side wall of the powder bottle (2) is connected to a rubber plate, the outer side of the rubber plate is connected to a support (3), the fire-extinguishing device may be mounted through the support (3), the rubber plate is elastic, which can reduce relative vibration between the powder bottle (2) and the support (3).

The trigger (8) is detonated through switching on a power supply when using the device, the piston (15) is pushed to move downwardly, the piston (15) pushes the puncture needle (14) to move downward to break the anti-vibration gasket and to puncture the puncture film (16) so as to enable the fire-extinguishing dry powder to be rapidly sputtered and released from the powder bottle (2), thereby achieving rapid fire-extinguishing effect. This fire-extinguishing device further includes a pressure sensor (22), through which the internal pressure of the powder bottle (2) may be sensed, when the pressure is not enough, it can be supplemented through the connector (1) in time, when the pressure is excessively high, it can be released by unscrewing a disposed safety screw. The anti-vibration gasket included in this fire-extinguishing device may prevent the puncture needle (14) from puncturing the puncture film (16) accidentally due to vibration in a moving state, such as in a vehicle, so as to ensure the fire-extinguishing device to be used in a moving state.

The above mentioned contents are better embodiments of the present disclosure only without limiting the present disclosure in any manners. Although the present disclosure has been disclosed as above in the better embodiments, the present disclosure is not limited thereto, without departing from the scope of the technical solution of the present disclosure, when slight changes, are made and equivalent embodiments are modified to be equivalently variable by any person skilled in the art using methods and technical contents disclosed as above, as long as contents do not depart from the technical solution of the present disclosure, any simple changes, equivalent variations and modifications of the embodiments described as above made by any person skilled in the art according to the technical substance of the present disclosure, still belong to the scope of the technical solution of the present disclosure.

1. An automatic fire-extinguishing and fire-fighting device for electric automobile, characterized in that comprising:
a powder bottle, a bottle head valve connected to the lower part of the powder bottle and a gas bottle connected to the lower part of the bottle head valve,
wherein the powder bottle is connected to the bottle head valve via a connecting piece.

2. The automatic fire-extinguishing and fire-fighting device for electric automobile of claim 1, characterized in that: the middle portion of the powder bottle is a cylinder, the top end portion and the bottom end portion thereof are cones, the top end portion of the powder bottle is connected with a connector, and the bottom end portion of the powder bottle is disposed with a connecting piece.

3. The automatic fire-extinguishing and fire-fighting device for electric automobile of claim 1, characterized in that: the connecting piece is in a truncated-cone-shape, a central gas outlet is disposed along an axis, three lateral gas outlets are uniformly distributed on a side surface, and an angle of 100 degrees is formed between the lateral gas outlets and the central axis of the powder bottle.

4. The automatic fire-extinguishing and fire-fighting device for electric automobile of claim 1, characterized in that: the bottle head valve includes a lower valve body, the upper part of the lower valve body is disposed with a transition valve body, and an upper valve body is disposed on the upper part of the transition valve body; a puncture needle is disposed within the transition valve body, and a piston is nested-mounted on the upper part of the puncture needle; a puncture film is disposed within the lower valve body, and an internal nut is disposed on the puncture film.

5. The automatic fire-extinguishing and fire-fighting device for electric automobile of claim 4, characterized in that: two gaskets having the same size are disposed on upper and lower parts of the puncture film, respectively.

6. The automatic fire-extinguishing and fire-fighting device for electric automobile of claim 4, characterized in that: the transition valve body is disposed with a first ladder hole and a second ladder hole having the same axis with the first ladder hole, a puncture needle runs through the second ladder hole, a piston is nested-mounted on the upper part of the puncture needle; a small hole at the middle of the second ladder hole slides to cooperate with the puncture needle, an upper hole thereof slides to cooperate with the piston, and a lower hole thereof is nested-mounted on the lower valve body; a puncture film is disposed at the bottom of the upper hole of the first ladder hole, an internal nut is disposed on the puncture film, an anti-vibration gasket is disposed on the upper part of the internal nut, the diameter of the lower part of the puncture needle is less than the diameter of the upper part of the puncture needle, and the transition surface thereof leans against the inner race of the anti-vibration gasket; the upper valve body is disposed with a third ladder hole having the same axis with the first ladder hole, the upper hole of the third ladder hole slides to cooperate with the puncture needle, and the lower hole thereof, the transition valve body, the upper part of the piston and the outer wall of the puncture needle form an annular sealed cavity, and a trigger is disposed within the annular sealed cavity.

7. The automatic fire-extinguishing and fire-fighting device for electric automobile of claim 6, characterized in that: a line pressing plate is disposed at a joint between the horizontal plane of the upper end portion of the transition valve body and the upper valve body, a lead hole is disposed on the line pressing plate, and the trigger is connected to a connecting box disposed on a shield through a lead passing through the lead hole.

8. The automatic fire-extinguishing and fire-fighting device for electric automobile of claim 6, characterized in that: the trigger is a powder blasting box or a powder cartridge made by suppressing powder.

9. The automatic fire-extinguishing and fire-fighting device for electric automobile of claim 6, characterized in that: the diameter of the lower part of the puncture needle is less than the diameter of the upper lower part thereof, the transition surface thereof leans against the inner race of the anti-vibration gasket, and the level angle of the tip of the puncture needle is ranging from 10 to 20 degrees.

10. The automatic fire-extinguishing and fire-fighting device for electric automobile of claim 6, characterized in that: the side wall of the transition valve body is opened with a gas exhausting hole, the lower part of the piston, the outer wall of the puncture needle and the transition valve body form an annular cavity, and the gas exhausting hole is connected with the annular cavity.

11. The automatic fire-extinguishing and fire-fighting device for electric automobile of claim 1, characterized in that: a gasket is disposed on the top end portion of the bottle head valve and the bottom of the connecting piece, and a cooper gasket for seal is disposed at a joint between the bottom of the bottle head valve and the gas bottle.

12. The automatic fire-extinguishing and fire-fighting device for electric automobile of claim 1, characterized in that: the powder bottle is welded with the connecting piece, the connecting piece is threaded connected to the bottle head valve, and the bottle head valve is threaded connected to the gas bottle.

13. The automatic fire-extinguishing and fire-fighting device for electric automobile of claim 1, characterized in that: the bottom of the powder bottle, the bottle head valve and the gas bottle are fixedly disposed within a shield, the gas bottle and the bottom of the shield flushes, the powder bottle is threaded connected to the shield, and the shield and the gas bottle are solidified with an anaerobic adhesive.

14. The automatic fire-extinguishing and fire-fighting device for electric automobile of claim 13, characterized in that: the powder bottle and the outer wall of the shield are both socketed with supports, and a rubber pad is disposed within the support.

15. The automatic fire-extinguishing and fire-fighting device for electric automobile of claim 1, characterized in that: a filing valve, a pressure sensor and a safety relief device are uniformly disposed along the circumference on the top of the gas bottle.
